(19) United States
(12) Patent Application Publication
(10) Pub. No.: US 2017/0362543 A1
(43) Pub. Date: Dec. 21, 2017

(54) Delayed-Release Particles

(71) Applicants: The Procter & Gamble Company, Cincinnati, OH (US); Agency for Science, Technology and Research, Singapore (SG)

(72) Inventors: Shoucang Shen, Jurong Island (SG); Tau Yee, Ron Lim, Jurong Island (SG); Saurabh Gupta, Mayspring (SG); Calum Macbeath, Singapore (SG); Robert Wayne Glenn, JR., Liberty Township, OH (US)

(21) Appl. No.: 15/623,907

(22) Filed: Jun. 15, 2017

Related U.S. Application Data
(60) Provisional application No. 62/351,326, filed on Jun. 17, 2016.

(51) Int. Cl. C11D 3/00; C11D 3/37; C11D 3/50; C11D 3/22; C11D 17/04; C11D 17/00

(52) U.S. Cl. CPC C11D 3/001; C11D 17/042; C11D 17/0039; C11D 3/505; C11D 3/227; C11D 3/3742; C11D 3/373; C11D 3/3776

(57) ABSTRACT

A delayed-release particle comprising a polymer-based matrix comprising polyvinylpyrrolidone and chitosan, and a hydrophobic benefit agent encapsulated by said polymer-based matrix; and processes and consumer products related thereto.

### FIELD OF THE INVENTION

The present disclosure relates to delayed-release particles and anhydrous compositions comprising the delayed-release particles.

### BACKGROUND OF THE INVENTION

Consumers desire consumer products for the many benefits they may provide. For example, it is not uncommon for a particular consumer to have and use shampoos, conditioners, laundry products, body washes, deodorants, and the like. Often, such consumer products also typically include hydrophobic benefit agents that provide benefits to the user of the consumer products. Often such hydrophobic benefit agents are incompatible with other chemistries included in the consumer product which may limit the delivery or function of the benefit agent, or impact stability of the consumer product. For example, when the consumer product includes a surfactant, the hydrophobic benefit agent may interact with the surfactant, resulting in negative interactions that may affect the deposition or function of the benefit agent, or stability of the consumer product. Thus, it can be desirable to protect the hydrophobic benefit agent from other ingredients of the consumer product, such as surfactant.

### SUMMARY OF THE INVENTION

The present invention relates to delayed-release solid particles comprising a polymer-based matrix and a hydrophobic benefit agent disposed within/encapsulated by the polymer-based matrix. The polymer-based matrix of the delayed-release solid particle comprises from about 20% to about 90%, by weight of the delayed-release solid particle, of polyvinylpyrrolidone and from about 0.15% to about 5%, by weight of the delayed-release solid particle, of chitosan. The polyvinylpyrrolidone and chitosan are present in a weight ratio of from about 30:1 to about 400:1. The hydrophobic benefit agent is present in an amount of from about 10% to about 80%, by weight of the delayed-release solid particle. The delayed-release solid particle is anhydrous, e.g. comprising less than about 15%, by weight of the delayed-release solid particle, of water.

The present invention further encompasses compositions comprising the delayed-release solid particle and adjunct ingredient(s), as well as consumer products comprising such compositions.

### BRIEF DESCRIPTION OF THE DRAWINGS

FIG. 1 is a side view of a tergetometer utilized in the RELEASE TEST METHOD.

FIG. 2 is a perspective view of the impeller of the tergetometer shown in FIG. 1.

FIG. 3 is a plot of the percent silicone released as a function of time from delayed-release solid particles of varying composition tested according to the RELEASE TEST METHOD.

FIGS. 4A-4F are micrographs illustrating the behavior of the delayed-release solid particle of Example 2 in contact with aqueous media and viewed under polarized microscope.

FIGS. 5A-5F are micrographs illustrating the behavior of the delayed-release solid particle of Example 4 in contact with aqueous media and viewed under polarized microscope.

FIGS. 6A-6F are micrographs illustrating the behavior of the delayed-release solid particle of Comparative Example A in contact with aqueous media and viewed under polarized microscope.

### DETAILED DESCRIPTION OF THE INVENTION

“Anhydrous” as used herein means a composition, a particle, or other material that contains water at a level below about 15%, preferably below about 10%, by weight of the composition, particle, or other material.

“Derivatives” as used herein, includes but is not limited to, amide, ether, ester, amino, carboxyl, acetyl, and/or alcohol derivatives of a given chemical.

The delayed-release solid particles disclosed herein comprise a hydrophobic benefit agent dispersed within and encapsulated by a polymer-based matrix comprising chitosan and polyvinylpyrrolidone (i.e. PVP). By varying the nature of the polymer-based matrix, in particular the weight ratio of polyvinylpyrrolidone to chitosan, the release rate of the hydrophobic benefit agent may be controlled. In this regard, the delayed-release solid particles described herein have a relatively slow release when exposed to an aqueous environment for a period of time followed by a sudden release of the benefit agent. By controlling the release profile of the benefit agent, the delayed-release particles may be advantageous for cleansing compositions because the particles protect the benefit agents from the negative interactions with cleansing agents that are often encountered early in the cleansing phase of laundry and hair cleansing products.

The delayed-release particles disclosed herein can be advantageous when incorporated into anhydrous consumer product compositions or consumer product articles that contain very little water, some non-limiting examples of which include granular detergents, dry shampoos, dry conditioners, cleaning webs, and unit dose products where said delayed-release particles may be separated from the aqueous components. Without being limited by theory, it is believed that the delayed-release particles disclosed herein swell when exposed to an aqueous environment containing an anionic surfactant, which are contained in many laundry/hair products. When the polymer-based matrix of the delayed-release particles lacks chitosan, then the particles quickly dissolve, providing a quick release profile. In contrast, when chitosan is incorporated into the polymer-based matrix, then it is believed that a short-lived aqueous polyvinylpyrrolidone gel forms, presumably caused by the interaction between the chitosan and anionic surfactant(s). Furthermore, increasing the amount of chitosan in the polymer-based matrix tends to prolong the time it takes to dissolve the polymer-based matrix and release the benefit agent.

### Polymer-Based Matrix

The delayed-release solid particles of the present invention comprise a polymer-based matrix that comprises polyvinylpyrrolidone and chitosan.

The polymer-based matrix serves to encapsulate the hydrophobic benefit agent of the delayed-release solid particle, thereby enabling the delayed release of the hydrophobic benefit agent.

### Polyvinylpyrrolidone

The polymer-based matrix of the delayed-release solid particles of the present invention comprises polyvinylpyrrolidone, which has the following structure:

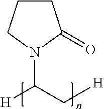

wherein n varies depending on the weight average molecular weight of the polyvinylpyrrolidone.

The weight average molecular weight (M_{w}) of the polyvinylpyrrolidone utilized in the delayed-release solid particle of the present invention can range from about 10,000 to about 360,000 Daltons, preferably from about 10,000 to about 80,000 Daltons. In a preferred non-limiting example, the polyvinylpyrrolidone has a weight average molecular weight of about 40,000 Daltons.

The polymer-based matrix of the delayed-release solid particles comprise from about 20% to about 80%, preferably from about 30% to about 80%, more preferably from about 40% to about 80%, by weight of the delayed-release solid particle, of polyvinylpyrrolidone.

### Chitosan

The polymer-based matrix of the delayed-release solid particles of the present invention further comprises chitosan, which has the following structure:

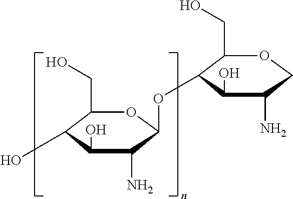

wherein n varies depending on the average molecular weight of the chitosan.

The viscosity average molecular weight (Mᵥ) of the chitosan utilized in the delayed-release solid particle of the present invention can range from about 1,500 to about 800,000 Daltons. Chitosan is commercially available from Sigma Aldrich as Low MW chitosan (50K-190K Daltons), Medium MW chitosan (190K-310K Daltons), and High MW chitosan (310K-375K Daltons). “Low MW” chitosan is preferred, i.e. chitosan having a Mᵥ of from about 50,000 to about 190,000 Daltons.

The delayed-release solid particles may comprise from about 0.15% to about 5%, preferably from about 0.2% to about 3%, more preferably from about 0.2% to about 2%, by weight of the delayed-release solid particle, of chitosan.

The amount of chitosan in the delayed-release solid particle, especially in relation to the amount of polyvinylpyrrolidone, can have an important impact on the ability of the delayed-release solid particle to release the hydrophobic benefit agent sufficiently in a controlled, delayed manner. If the amount of chitosan is too low (especially in relation to the amount of polyvinylpyrrolidone), the hydrophobic benefit agent can be released too quickly from the delayed-release solid particle. If the amount of chitosan is too high (especially in relation to the amount of polyvinylpyrrolidone), the hydrophobic benefit agent may not be sufficiently released from the delayed-release solid particle.

The delayed-release solid particles will thus comprise a weight ratio of polyvinylpyrrolidone to chitosan of from about 30:1 to about 400:1, preferably from about 30:1 to about 300:1, more preferably from about 30:1 to about 200:1, more preferably from about 30:1 to about 100:1, and more preferably from about 40:1 to about 50:1.

### Hydrophobic Benefit Agent

The delayed-release solid particle of the present invention comprises a hydrophobic benefit agent disposed within and encapsulated by the polymer-based matrix of the delayed-release solid particle. The hydrophobic benefit agent of the present invention functions to provide benefits to the consumer, such as enhancing surfaces treated with the consumer product composition to provide improved hand feel benefits (e.g. soft, silky feel), softness benefits, odor benefits, or the like.

Hydrophobic benefit agents can include materials which are used to give a particular conditioning benefit (i.e. softening benefit) to hair, skin, and/or fabrics. Suitable hydrophobic conditioning agents include those which deliver one or more benefits relating to shine, softness, comb-ability, antistatic properties, anti-wrinkle properties, wet-handling, fiber damage prevention, manageability, body, and greasiness. The conditioning agents useful in the compositions of the present invention typically comprise a water-insoluble, non-volatile liquid. Suitable conditioning agents for use in the composition are those conditioning agents characterized generally as silicones (e.g., silicone oils, aminosilicones, cationic silicones, silicone gums, high refractive silicones, functionalized silicones, silicone resins, alkyl siloxane polymers, and cationic organopolysiloxanes), organic conditioning oils (e.g., hydrocarbon oils, polyolefins, fatty esters, metathesized unsaturated polyol esters, and silane-modified oils) or combinations thereof. Suitable conditioning agents are selected from the group consisting of silicones, organic conditioning oils, hydrocarbon oils, fatty esters, metathesized unsaturated polyol esters, silane-modified oils, other conditioning agents, and mixtures thereof.

Suitable hydrophobic benefit agents can also include materials that provide odor benefits, such as perfume.

In one aspect, the hydrophobic benefit agent is selected from the group consisting of silicones, organic conditioning oils, hydrocarbon oils, fatty esters, metathesized unsaturated polyol esters, silane-modified oils, other conditioning agents, perfume, and mixtures thereof.

The concentration of the hydrophobic benefit agent in the composition should be sufficient to provide the desired consumer benefits. Such concentration can vary with the benefit agent, the level of performance desired, the type and concentration of other components, and other like factors such as dosage amount at point of use by the consumer.

In preferred aspects, the hydrophobic benefit agent is liquid at ambient temperature (e.g. 25° C.).

The delayed-release solid particle of the present invention will typically comprise hydrophobic benefit agent at a level of from about 10% to about 80%, preferably from about 15% to about 60%, more preferably from about 20% to about 40%, by weight of the delayed-release solid particle.

### Silicones

The hydrophobic benefit agent of the delayed-release solid particle of the present invention is preferably a water-insoluble silicone benefit agent. The silicone benefit agent may comprise volatile silicone, non-volatile silicone, or combinations thereof. Preferred are non-volatile silicone benefit agents. If volatile silicones are present, it will typically be incidental to their use as a solvent or carrier for commercially available forms of non-volatile silicone material ingredients, such as silicone gums and resins. The silicone benefit agent may comprise a silicone fluid conditioning agent and may also comprise other ingredients, such as a silicone resin to improve silicone fluid deposition efficiency.

Suitable silicones are selected from the group consisting of siloxanes, silicone gums, aminosilicones, terminal aminosilicones, alkyl siloxane polymers, cationic organopolysiloxanes, and mixtures thereof. Preferably the silicone is an aminosilicone, more preferably a terminal aminosilicone.

The hydrophobic benefit agents of the present invention may comprise one or more silicones including high molecular weight polyalkyl or polyaryl siloxanes and silicone gums; lower molecular weight polydimethyl siloxane fluids; and aminosilicones.

Higher molecular weight silicone compounds useful herein include polyalkyl or polyaryl siloxanes with the following structure:

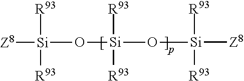

wherein R⁹³ is alkyl or aryl, and p is an integer from about 1,300 to about 15,000, more preferably from about 1,600 to about 15,000. Z⁸ represents groups which block the ends of the silicone chains. The alkyl or aryl groups substituted on the siloxane chain (R⁹³) or at the ends of the siloxane chains Z⁸ can have any structure as long as the resulting silicone remains fluid at room temperature, is neither irritating, toxic nor otherwise harmful, is compatible with the other components of the composition, is chemically stable under normal use and storage conditions, and is capable of being deposited on the target surface. Suitable Z⁸ groups include hydroxy, methyl, methoxy, ethoxy, propoxy, and aryloxy. The R⁹³ groups may represent the same group or different groups. Preferably, the R⁹³ groups represent the same group. Suitable R⁹³ groups include methyl, ethyl, propyl, phenyl, methylphenyl and phenylmethyl. Other silicone compounds include polydimethylsiloxane, polydiethylsiloxane, and polymethylphenylsiloxane. Commercially available silicone compounds useful herein include, for example, those available from the General Electric Company in their TSF451 series, and those available from Dow Corning in their Dow Corning SH200 series.

The silicone compounds that can be used herein can also include a silicone gum. The term “silicone gum”, as used herein, means a polyorganosiloxane material having a viscosity at 25° C. of greater than or equal to 1,000 Pa·s. It is recognized that the silicone gums described herein can also have some overlap with the above-disclosed silicone compounds. This overlap is not intended as a limitation on any of these materials. The “silicone gums” will typically have a molecular weight in excess of about 165,000, generally between about 165,000 and about 1,000,000. Specific examples include polydimethylsiloxane, poly(dimethylsiloxane methylvinylsiloxane) copolymer, poly(dimethylsiloxane diphenylsiloxane methylvinylsiloxane) copolymer and mixtures thereof. Commercially available silicone gums useful herein include, for example, TSE200A and CF330M available from the General Electric Company.

Lower molecular weight silicone compounds useful herein include polyalkyl or polyaryl siloxanes with the following structure:

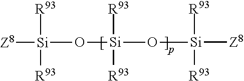

wherein R⁹³ is alkyl or aryl, and p is an integer from about 7 to about 850, more preferably from about 7 to about 665. Z⁸ represents groups which block the ends of the silicone chains. The alkyl or aryl groups substituted on the siloxane chain (R⁹³) or at the ends of the siloxane chains Z⁸ can have any structure as long as the resulting silicone remains fluid at room temperature, is neither irritating, toxic nor otherwise harmful, is compatible with the other components of the composition, is chemically stable under normal use and storage conditions, and is capable of being deposited on the target surface. Suitable Z⁸ groups include hydroxy, methyl, methoxy, ethoxy, propoxy, and aryloxy. The R⁹³ groups may represent the same group or different groups. Preferably, the R⁹³ groups represent the same group. Suitable R⁹³ groups include methyl, ethyl, propyl, phenyl, methylphenyl and phenylmethyl. Other silicone compounds include polydimethylsiloxane, polydiethylsiloxane, and polymethylphenylsiloxane. Commercially available these silicone compounds useful herein include, for example, those available from the General Electric Company in their TSF451 series, and those available from Dow Corning in their Dow Corning SH200 series.

In one aspect, the hydrophobic benefit agent of the present invention includes one or more aminosilicones. Aminosilicones, as provided herein, are silicones containing at least one primary amine, secondary amine, tertiary amine, or quaternary ammonium group.

Non-limiting examples of aminosilicones for use in aspects of the subject invention include, but are not limited to, those which conform to the general formula (I):

(R¹)ₐG₍₃₋ₐ₎-Si—(—OSiG₂)ₙ-(—OSiG_{b}(R¹)_{2-b})ₘ—O—SiG₍₃₋ₐ₎(R¹)ₐ (I)

wherein G is hydrogen, phenyl, hydroxy, or C₁-C₈ alkyl, preferably methyl; a is 0 or an integer having a value from 1 to 3, preferably 1; b is 0, 1, or 2, preferably 1; wherein when a is 0, b is not 2; n is a number from 0 to 1,999; m is an integer from 0 to 1,999; the sum of n and m is a number from 1 to 2,000; a and m are not both 0; R¹ is a monovalent radical conforming to the general formula CqH_{2q}L, wherein q is an integer having a value from 2 to 8 and L comprises at least one amine group. Preferably L is selected from the following groups: —N(R²)CH₂—CH₂—N(R²)₂; —N(R²)₂; —N(R²)⁺₃A⁻; —N(R²)CH₂—CH₂—N R²H₂A⁻; wherein R² is hydrogen, phenyl, benzyl, or a saturated hydrocarbon radical, preferably an alkyl radical from about C₁ to about C₂₀; A⁻ is a halide ion.

A suitable aminosilicone utilized herein is commercially available from Momentive Performance Materials Inc. under the tradename MAGNASOFT PLUS, which has the following structure:

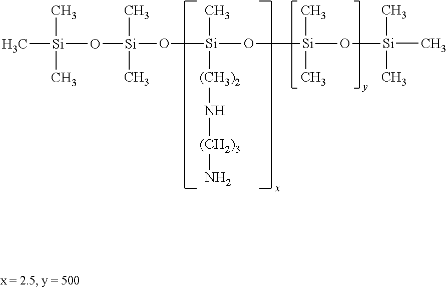

wherein x is 2.5 and y is 500.

Some silicones for use herein can include those aminosilicones that correspond to formula (I) wherein m=0, a=1, q=3, G=methyl, n is preferably from about 1500 to about 1700, more preferably about 1600; and L is —N(CH₃)₂ or —NH₂, more preferably —NH₂. Other aminosilicones can include those corresponding to formula (I) wherein m=0, a=1, q=3, G=methyl, n is preferably from about 400 to about 600, more preferably about 500; and L is —N(CH₃)₂ or —NH₂, more preferably —NH₂. These aminosilicones can be called as terminal aminosilicones, as one or both ends of the silicone chain are terminated by nitrogen containing group.

An exemplary aminosilicone corresponding to formula (I) is the polymer known as “trimethylsilylamodimethicone”, which is shown below in formula (II):

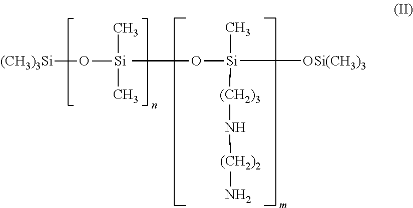

wherein n is a number from 1 to 1,999 and m is a number from 1 to 1,999.

The silicone may also be a terminal aminosilicone. “Terminal aminosilicone” as defined herein means a silicone polymer comprising one or more amino groups at one or both ends of the silicone backbone. In one aspect, the hydrophobic conditioning agent consists of only terminal amino silicones.

In one aspect, the amino group at the at least one terminus of the silicone backbone of the terminal aminosilicone is selected from the group consisting of: primary amines, secondary amines and tertiary amines. The terminal aminosilicone may conform to Formula III:

(R₁)ₐG₍₃₋ₐ₎-Si—(—OSiG₂)ₙ—O-SiG₍₃₋ₐ₎(R₁)ₐ III

wherein G is hydrogen, phenyl, hydroxy, or C₁-C₈ alkyl, preferably methyl; a is an integer having a value from 1 to 3, or preferably is 1; n is a number from 0 to 1,999; R₁ is a monovalent radical conforming to the general formula CqH_{2q}L, wherein q is an integer having a value from 2 to 8 and L comprises at least one amine group. Preferably L is selected from the following groups: —N(R₂)CH₂—CH₂—N(R₂)₂; —N(R₂)₂; —N⁺(R₂)₃A⁻; —N(R₂)CH₂—CH₂—N⁺R₂H₂A⁻; wherein R₂ is hydrogen, phenyl, benzyl, or a saturated hydrocarbon radical; A is a halide ion. In an aspect, R₂ is an alkyl radical having from 1 to 20 carbon atoms, or from 2 to 18 carbon atoms, or from 4 to 12 carbon atoms.

A suitable terminal aminosilicone corresponding to Formula III has a=1, q=3, G=methyl, n is from about 1000 to about 2500, alternatively from about 1500 to about 1700; and L is —N(CH₃)₂. In an aspect, R₂ is an alkyl radical having from 1 to 20 carbon atoms, or from 2 to 18 carbon atoms, or from 4 to 12 carbon atoms. In an aspect, the terminal aminosilicone is selected from the group consisting of bis-aminomethyl dimethicone, bis-aminoethyl dimethicone, bis-aminopropyl dimethicone, bis-aminobutyl dimethicone, and mixtures thereof.

Suitable silicones further include aminopropyl terminated polydimethylsiloxane (e.g. having a viscosity of 4,000-6,000 cSt (4-6 Pa·s); available under the tradename DMS-A35 from Gelest, Inc.), polydimethylsiloxane, trimethylsiloxy terminated (e.g. having a viscosity of 5,000 cSt (5 Pa·s); available under the tradename DMS-T35 from Gelest, Inc.), polydimethylsiloxane, trimethylsiloxy terminated (e.g. having a viscosity of 1,000 cSt (1 Pa·s); available under the tradename DMS-T31 from Gelest, Inc.), aminopropyl terminated polydimethylsiloxane (e.g. having a viscosity of 900-1,100 cSt (0.9-1.1 Pa·s); available under the tradename DMS-A31 from Gelest, Inc.), polydimethylsiloxane, trimethylsiloxy terminated (e.g. having a viscosity of 50 cSt (0.05 Pa·s); available under the tradename DMS-T15 from Gelest, Inc.), aminopropyl terminated polydimethylsiloxane (e.g. having a viscosity of 50-60 cSt (0.05-0.06 Pa·s); available under the tradename DMS-A15 from Gelest, Inc.), bis-aminopropyl dimethicone (e.g. having a viscosity of 10,220 cSt (10.2 Pa·s); available from Momentive Performance Materials Inc.), and mixtures thereof.

### Alkyl Siloxane Polymer

Suitable conditioning agents as benefit agents further include alkyl siloxane polymers, as described in detail in US 2011/0243874 A1, US 2011/0243875 A1, US 2011/0240065 A1, US 2011/0243878A1, US 2011/0243871 A1, and US 2011/0243876 A1.

### Cationic Organopolysiloxanes

Suitable conditioning agents as benefit agents further include cationic organopolysiloxanes, as described in detail in US 2014/0030206 A1, WO 2014/018985 A1, WO 2014/018986 A1, WO 2014/018987 A1, WO 2014/018988 A1, and WO 2014/018989 A1.

### Organic Conditioning Oils

The hydrophobic benefit agent of the particles of the present invention may also comprise at least one organic conditioning oil as the benefit agent, either alone or in combination with other benefit agents, such as the silicones. Suitable organic conditioning oils include hydrocarbon oils, polyolefins, fatty esters, methathesized unsaturated polyol esters, or silane-modified oils.

### Hydrocarbon Oils

Suitable organic conditioning oils for use as benefit agents in the particles of the present invention include, but are not limited to, hydrocarbon oils having at least about 10 carbon atoms, such as cyclic hydrocarbons, straight chain aliphatic hydrocarbons (saturated or unsaturated), and branched chain aliphatic hydrocarbons (saturated or unsaturated), including polymers and mixtures thereof. Straight chain hydrocarbon oils preferably are from about C₁₂ to about C₂₂.

Specific non-limiting examples of these hydrocarbon oils include paraffin oil, mineral oil, saturated and unsaturated dodecane, saturated and unsaturated tridecane, saturated and unsaturated tetradecane, saturated and unsaturated pentadecane, saturated and unsaturated hexadecane, polybutene, polyisobutylene, polydecene, and mixtures thereof. Branched-chain isomers of these compounds, as well as of higher chain length hydrocarbons, can also be used, examples of which include highly branched, saturated or unsaturated, alkanes such as the permethyl-substituted isomers, e.g., the permethyl-substituted isomers of hexadecane and eicosane, such as 2, 2, 4, 4, 6, 6, 8, 8-dimethyl-10-methylundecane and 2, 2, 4, 4, 6, 6-dimethyl-8-methylnonane, available from Permethyl Corporation. Hydrocarbon polymers such as polybutene and polydecene. A preferred hydrocarbon polymer is polybutene, such as the copolymer of isobutylene and butene. A commercially available material of this type is L-14 polybutene from Amoco Chemical Corporation. Another preferred hydrocarbon polymer is polyisobutylene, a non-limiting example being polyisobutylene having a number average molecular weight of 1,000 and commercially available from EVONIK Industries AG under the trade name REWOPAL PIB 1000.

### Polyolefins

Organic conditioning oils for use in the particles of the present invention can also include liquid polyolefins, liquid poly-α-olefins, hydrogenated liquid poly-α-olefins, and the like. Polyolefins for use herein are prepared by polymerization of C₄ to about C₁₄ olefenic monomers.

Non-limiting examples of olefenic monomers for use in preparing the polyolefin liquids herein include ethylene, propylene, butene (including isobutene), pentene, hexene, octene, decene, dodecene, tetradecene, branched chain isomers such as 4-methyl-1-pentene, and mixtures thereof. Also suitable for preparing the polyolefin liquids are olefin-containing refinery feedstocks or effluents. Hydrogenated α-olefin monomers include, but are not limited to: 1-hexene to 1-hexadecenes, 1-octene to 1-tetradecene, and mixtures thereof.

### Fatty Esters

Other suitable organic conditioning oils for use as benefit agents in the particles of the present invention include, but are not limited to, fatty esters having at least 10 carbon atoms. These fatty esters include esters with hydrocarbyl chains derived from fatty acids or alcohols (e.g. mono-esters, polyhydric alcohol esters, and di- and tri-carboxylic acid esters). The hydrocarbyl radicals of the fatty esters hereof may include or have covalently bonded thereto other compatible functionalities, such as amides and alkoxy moieties (e.g., ethoxy or ether linkages, etc.).

Specific examples of fatty esters include, but are not limited to: isopropyl isostearate, hexyl laurate, isohexyl laurate, isohexyl palmitate, isopropyl palmitate, decyl oleate, isodecyl oleate, hexadecyl stearate, decyl stearate, isopropyl isostearate, dihexyldecyl adipate, lauryl lactate, myristyl lactate, cetyl lactate, oleyl stearate, oleyl oleate, oleyl myristate, lauryl acetate, cetyl propionate, and oleyl adipate.

Other fatty esters suitable for use in the particles of the present invention are mono-carboxylic acid esters of the general formula R′COOR, wherein R′ and R are alkyl or alkenyl radicals, and the sum of carbon atoms in R and R is at least 10, preferably at least 22.

Still other fatty esters suitable for use in the particles of the present invention are di- and tri-alkyl and alkenyl esters of carboxylic acids, such as esters of C₄ to C₈ dicarboxylic acids (e.g. C₁ to C₂₂ esters, preferably C₁ to C₆, of succinic acid, glutaric acid, and adipic acid). Specific non-limiting examples of di- and tri-alkyl and alkenyl esters of carboxylic acids include isocetyl stearyol stearate, diisopropyl adipate, and tristearyl citrate.

Other fatty esters suitable for use in the particles of the present invention are those known as polyhydric alcohol esters. Such polyhydric alcohol esters include alkylene glycol esters, such as ethylene glycol mono and di-fatty acids, diethylene glycol mono- and di-fatty acid esters, polyethylene glycol mono- and di-fatty acid esters, propylene glycol mono- and di-fatty acid esters, polypropylene glycol monooleate, polypropylene glycol 2000 monostearate, ethoxylated propylene glycol monostearate, glyceryl mono- and di-fatty acid esters, polyglycerol poly-fatty acid esters, ethoxylated glyceryl monostearate, 1,3-butylene glycol monostearate, 1,3-butylene glycol distearate, polyoxyethylene polyol fatty acid ester, sorbitan fatty acid esters, and polyoxyethylene sorbitan fatty acid esters.

Still other fatty esters suitable for use in the particles of the present invention are glycerides, including, but not limited to, mono-, di-, and tri-glycerides, preferably di- and tri-glycerides, more preferably triglycerides. For use in the particles described herein, the glycerides are preferably the mono-, di-, and tri-esters of glycerol and long chain carboxylic acids, such as C₁₀ to C₂₂ carboxylic acids. A variety of these types of materials can be obtained from vegetable and animal fats and oils, such as castor oil, safflower oil, cottonseed oil, corn oil, olive oil, cod liver oil, almond oil, avocado oil, palm oil, sesame oil, lanolin and soybean oil. Synthetic oils include, but are not limited to, triolein and tristearin glyceryl dilaurate.

Other fatty esters suitable for use in the particles of the present invention are water insoluble synthetic fatty esters. Some preferred synthetic esters conform to the general Formula (IX):

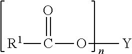

wherein R¹ is a C₇ to C₉ alkyl, alkenyl, hydroxyalkyl or hydroxyalkenyl group, preferably a saturated alkyl group, more preferably a saturated, linear, alkyl group; n is a positive integer having a value from 2 to 4, preferably 3; and Y is an alkyl, alkenyl, hydroxy or carboxy substituted alkyl or alkenyl, having from about 2 to about 20 carbon atoms, preferably from about 3 to about 14 carbon atoms. Other preferred synthetic esters conform to the general Formula (X):

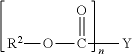

wherein R² is a C₈ to C₁₀ alkyl, alkenyl, hydroxyalkyl or hydroxyalkenyl group; preferably a saturated alkyl group, more preferably a saturated, linear, alkyl group; n and Y are as defined above in Formula (X).

Specific non-limiting examples of suitable synthetic fatty esters for use in the compositions of the present invention include: P-43 (C₈-C₁₀ triester of trimethylolpropane), MCP-684 (tetraester of 3,3 diethanol-1,5 pentadiol), MCP 121 (C₈-C₁₀ diester of adipic acid), all of which are available from Mobil Chemical Company.

### Metathesized Unsaturated Polyol Esters

Other suitable organic conditioning oils as benefit agents include metathesized unsaturated polyol esters. Exemplary metathesized unsaturated polyol esters and their starting materials are set forth in US 2009/0220443 A1. A metathesized unsaturated polyol ester refers to the product obtained when one or more unsaturated polyol ester ingredient(s) are subjected to a metathesis reaction. Metathesis is a catalytic reaction that involves the interchange of alkylidene units among compounds containing one or more double bonds (i.e., olefinic compounds) via the formation and cleavage of the carbon-carbon double bonds. Metathesis may occur between two of the same molecules (often referred to as self-metathesis) and/or it may occur between two different molecules (often referred to as cross-metathesis).

### Silane-Modified Oils

Other suitable organic conditioning oils as benefit agents include silane-modified oils. In general, suitable silane-modified oils comprise a hydrocarbon chain selected from the group consisting of saturated oil, unsaturated oil, and mixtures thereof; and a hydrolysable silyl group covalently bonded to the hydrocarbon chain. Suitable silane-modified oils are described in detail in U.S. Application Ser. No. 61/821,818, filed May 10, 2013.

### Other Conditioning Agents

Also suitable for use in the particles herein are the conditioning agents described by the Procter & Gamble Company in U.S. Pat. Nos. 5,674,478, and 5,750,122. Also suitable for use herein are those conditioning agents described in U.S. Pat. No. 4,529,586 (Clairol), U.S. Pat. No. 4,507,280 (Clairol), U.S. Pat. No. 4,663,158 (Clairol), U.S. Pat. No. 4,197,865 (L'Oreal), U.S. Pat. No. 4,217,914 (L'Oreal), U.S. Pat. No. 4,381,919 (L'Oreal), and U.S. Pat. No. 4,422,853 (L'Oreal).

### Perfume

The hydrophobic benefit agent of the present invention may also include one or more perfumes. The one or more perfumes may be selected from any perfume or perfume chemical suitable for topical application to the skin and/or hair and suitable for use in personal care compositions. The concentration of the perfume in the personal care composition should be effective to provide the desired aroma including, but not limited to, unscented. Generally, the concentration of the scented primary perfume is from about 0.5% to about 30%, in one aspect from about 1% to about 20%, in yet another aspect from about 2% to about 10%, and in yet another aspect from about 3% to about 8%, by weight of the solid article.

The perfume may be selected from the group consisting of perfumes, highly volatile perfume materials having a boiling point of less than about 250° C., and mixtures thereof. In one aspect, the perfume is selected from high impact accord perfume ingredients having a C log P of greater than about 2 and odor detection thresholds of less than or equal to 50 parts per billion (ppb).

### Emulsification Agent

In some aspects of the present invention, the delayed-release solid particles may optionally further comprise an emulsification agent. The emulsification agent can be utilized, for example, to emulsify the hydrophobic benefit agent, especially for subsequent combination with the polymer-based matrix comprising polyvinylpyrrolidone and chitosan.

Non-limiting examples of emulsification agents include surfactants. Suitable surfactants include nonionic surfactants, non-limiting examples of which include secondary alcohol ethoxylates such as TERGITOL™. Other non-limiting examples of useful nonionic surfactants include nonylphenol ethoxylate (TERGITOL NP-10), alkyl polyethylene glycol ether (e.g. 2-methyl-oxirane polymer with mono(2-propylheptyl)oxirane ether available as LUTENSOL XL 70™), and alcohol alkoxylates available under the trade name ECOSURF™.

The delayed-release solid particles can further optionally comprise from about 1% to about 15%, preferably from about 1% to about 10%, more preferably from about 1% to about 5%, by weight of the delayed-release solid particle, of an emulsification agent.

Other agents such as acetic acid can be utilized to further enhance the solubilization of chitosan in the polymer-based matrix solution.

The delayed-release solid particles are anhydrous, i.e. the particles comprise less than about 15%, preferably less than about 10%, by weight of the particle, of water.

In some aspects, the delayed-release solid particle comprises from 0.15% to 5%, by weight, of chitosan; from 20% to 90%, by weight, of polyvinylpyrrolidone; from 10% to 80%, by weight, of the hydrophobic benefit agent; and from 1% to 15%, by weight, of the emulsification agent.

The delayed-release solid particles disclosed herein may have an average particle size of 1 to 3000 micrometers, preferably 1 to 500 micrometers. Average particle size of the delayed-release solid particle is determined using laser diffraction via commercially available Malvern Mastersizer equirement (a dry dispersion method).

In some aspects, the delayed-release solid particles disclosed herein may release less than 5% by weight of the encapsulated hydrophobic benefit agent within 5 minutes of exposure to aqueous media, and greater than 5% by weight after 20 minutes, as measured by the RELEASE TEST METHOD described herein. In some examples, the delayed-release solid particles disclosed herein may release less than 10% by weight of the encapsulated benefit agent within 10 minutes of exposure to water, and greater than 10% by weight after 20 minutes, as measured by the RELEASE TEST METHOD described herein.

### Process for Making Delayed-Release Solid Particles

The present invention further relates to a process for making a delayed-release solid particle comprising the steps of: preparing a benefit agent solution comprising the hydrophobic benefit agent; mixing the polyvinylpyrrolidone, chitosan, and water to form a polymer solution; mixing the benefit agent solution and the polymer solution to form a mixture solution; and removing water from the mixture solution to form the delayed-release solid particle. The step of removing water preferably comprises spray drying the mixture solution to form the delayed-release solid particle.

### Consumer Products

The present invention further relates to consumer product compositions or consumer product articles comprising the delayed-release solid particles described herein. Consumer product compositions comprising delayed-release solid particles may be packaged in any package known in the art and sold as consumer products (i.e. products intended to be sold to consumers without further modification or processing). Additionally, delayed-release solid particles may be applied to any article, such as a fabric or any absorbent material including, but not limited to, feminine hygiene products, diapers, and adult incontinence products. The composition containing the delayed-release solid particles may also be incorporated into an article, non-limiting examples of which include a dispenser/container. The compositions/articles disclosed herein may be made by combining the delayed-release solid particles disclosed herein with the desired adjunct material to form the consumer product. In some examples, the delayed-release solid particles are incorporated into an anhydrous consumer product composition. In some examples, the anhydrous composition containing the delayed-release solid particles is a personal care composition, fabric care composition, or a home care composition.

Suitable equipment for use in the processes disclosed herein may include continuous stirred tank reactors, homogenizers, turbine agitators, recirculating pumps, paddle mixers, plough shear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., U.S.A.), Arde Barinco (New Jersey, U.S.A.).

Non-limiting examples of consumer products useful herein include products for treating hair (human, dog, and/or cat), conditioning, growing, removing, retarding growth, shampooing, styling; deodorants and antiperspirants; personal cleansing; color cosmetics; products, and/or methods relating to treating skin (human, dog, and/or cat), including application of creams, lotions, and other topically applied products for consumer use; and products and/or methods relating; shaving; body sprays; and fine fragrances like colognes and perfumes; products for treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products relating to disposable absorbent and/or non-absorbent articles including adult incontinence garments, bibs, diapers, training pants, infant and toddler care wipes; hand soaps, shampoos, lotions, oral care implements, and clothing; products such as wet or dry bath tissue, facial tissue, disposable handkerchiefs, disposable towels, and/or wipes; products relating to catamenial pads, incontinence pads, interlabial pads, panty liners, pessaries, sanitary napkins, tampons and tampon applicators, and/or wipes.

In some examples, the consumer product may be a personal care composition, that is, a composition intended to be applied anywhere on the human body for any period of time. Non-limiting examples of personal care compositions include products such as those intended to treat and/or clean hair, styling products, deodorants and antiperspirants, personal cleansing products, cosmetics products, product relating to treating skin such as creams, lotions, and other topically applied products for consumer use; shaving products; body sprays; and fine fragrances like colognes and perfumes. The personal care compositions may be manufactured by any method known in the art and packaged in any dispenser known in the art. In some examples, the personal care composition may include from about 0.01% to about 20%, by weight of the personal care composition, of the delayed-release solid particles.

In some examples, the consumer product may include a fabric and home care composition. In some examples, the fabric and home care composition may include from about 0.01% to about 20%, by weight of the composition, of delayed-release solid particles. As used herein, the term “fabric and home care compositions” include, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshening that may be in liquid, solid and/or dryer sheet form; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products which are applicable may be in standard, concentrated or even highly concentrated form even to the extent that such products may in certain aspect be non-aqueous.

Anhydrous compositions containing the delayed-release solid particles may also be incorporated into a unit dose consumer product such as a single unit dose or into a compartment of a multi-compartment unit dose consumer product. Unit doses are easy to handle avoid the need for consumers to measure the product, giving rise to more precise dosing and avoids wasteful overdosing or under-dosing. Often, the unit-dose is in the form of a water-soluble pouch comprising a powder and/or liquid composition. The pouch often has a closed structure, made of materials described herein, enclosing a volume space. In some examples, the volume space is separated into at least two compartments.

The pouch can be of any form, shape and material which is suitable to hold the composition, e.g. without allowing the release of the composition from the pouch prior to contact of the pouch with water. The exact execution will depend, for example, on the type and amount of the composition in the pouch, the number of compartments in the pouch, and on the characteristics required from the pouch to hold, protect and deliver or release the composition(s).

Preferably, the water-soluble unit-dose pouch comprises at least a first compartment and a second compartment, wherein the first and/or second compartment comprises an anhydrous composition comprising delayed-release solid particles of the present invention. Preferably, another composition present in the other compartment is selected from the group comprising, liquid, gel, powder, granule, or tablet. It can be advantageous to have multiple compartments in a single water-soluble unit-dose pouch, as this allows the combination of incompatible components and components requiring dry or liquid environments.

The pouch is preferably made of a film material wherein the film material is soluble or dispersible in water. Preferred pouch materials are polymeric materials, preferably polymers which are formed into a film or sheet. The pouch material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. The polymer can have any weight average molecular weight, preferably from about 1000 to 1,000,000, more preferably from about 10,000 to 300,000 yet more preferably from about 20,000 to 150,000.

The pouches disclosed herein may be made using any suitable equipment and method. Single compartment pouches are made using vertical, but preferably horizontal form filling techniques commonly known in the art.

In some examples, the anhydrous composition only includes delayed-release solid particles in powder form. In some examples, the anhydrous composition includes delayed-release solid particles and an anhydrous carrier.

The compositions comprising delayed-release solid particles of the present invention may also include one or more adjunct ingredients. An adjunct ingredient is any material that is not a delayed-release solid particle and that is added to the delayed-release solid particle to form a consumer product. The adjunct ingredient may take many forms, and it is to be appreciated that an adjunct ingredient may be a pure substance or include more than one type of material such that the adjunct ingredient is collection/mixture of different materials, arranged in any manner Non-limiting examples of adjunct ingredients include: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids, structurants, anti-agglomeration agents, coatings, formaldehyde scavengers and/or pigments, and combinations thereof. Other embodiments may not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids, structurants, anti-agglomeration agents, coatings, formaldehyde scavengers and/or pigments. The precise nature of these additional components, and levels of incorporation thereof, will depend on the physical form of the composition and the nature of the operation for which it is to be used. However, when one or more adjunct materials are present, such one or more adjunct materials may be present as detailed below. The following is a non-limiting list of suitable adjunct materials.

Surfactants: Surfactants utilized may be of the anionic, nonionic, zwitterionic, ampholytic or cationic type or may comprise compatible mixtures of these types. Anionic and nonionic surfactants are typically employed if the composition is a laundry detergent. In contrast, cationic surfactants are typically employed if the composition is a fabric softener. In addition to the anionic surfactant, the compositions may further contain a nonionic surfactant. The compositions may contain up to from 0.01% to about 30%, alternatively from about 0.01% to about 20%, more alternatively from about 0.1% to about 10%, by weight of the composition, of a nonionic surfactant. In some examples, the nonionic surfactant may comprise an ethoxylated nonionic surfactant. Suitable for use herein are the ethoxylated alcohols and ethoxylated alkyl phenols of the formula R(OC₂H₄)n OH, wherein R is selected from the group consisting of aliphatic hydrocarbon radicals containing from about 8 to about 20 carbon atoms and alkyl phenyl radicals in which the alkyl groups contain from about 8 to about 12 carbon atoms, and the average value of n is from about 5 to about 15.

Suitable nonionic surfactants are those of the formula R1(OC₂H₄)nOH, wherein R1 is a C₁₀-C₁₆ alkyl group or a C₈-C₁₂ alkyl phenyl group, and n is from 3 to about 80. In one aspect, particularly useful materials are condensation products of C₉-C₁₅ alcohols with from about 5 to about 20 moles of ethylene oxide per mole of alcohol.

The fabric and home care compositions may contain up to about 30%, alternatively from about 0.01% to about 20%, more alternatively from about 0.1% to about 20%, by weight of the composition, of a cationic surfactant. Cationic surfactants include those which can deliver fabric care benefits, non-limiting examples which include: fatty amines; quaternary ammonium surfactants; and imidazoline quat materials.

Non-limiting examples of fabric softening actives are N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl)N-(2 hydroxyethyl)N-methyl ammonium methylsulfate; 1, 2 di (stearoyl-oxy) 3 trimethyl ammoniumpropane chloride; dialkylenedimethylammonium salts such as dicanoladimethylammonium chloride, di(hard)tallowdimethylammonium chloride dicanoladimethylammonium methylsulfate; 1-methyl-1-stearoylamidoethyl-2-stearoylimidazolinium methylsulfate; 1-tallowylamidoethyl-2-tallowylimidazoline; N,N″-dialkyldiethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid; polyglycerol esters (PGEs), oily sugar derivatives, and wax emulsions and a mixture of the above.

It will be understood that combinations of softener actives disclosed above are suitable for use herein.

Builders—The compositions may also contain from about 0.1% to 80% by weight of the composition of a builder. Compositions in liquid form generally contain from about 1% to 10% by weight of the composition of the builder component. Compositions in granular form generally contain from about 1% to 50% by weight of the composition of the builder component. Detergent builders are well known in the art and can contain, for example, phosphate salts as well as various organic and inorganic nonphosphorus builders. Water-soluble, nonphosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid. Other polycarboxylate builders are the oxydisuccinates and the ether carboxylate builder compositions comprising a combination of tartrate monosuccinate and tartrate disuccinate. Builders for use in liquid detergents include citric acid. Suitable nonphosphorus, inorganic builders include the silicates, aluminosilicates, borates and carbonates, such as sodium and potassium carbonate, bicarbonate, sesquicarbonate, tetraborate decahydrate, and silicates having a weight ratio of SiO2 to alkali metal oxide of from about 0.5 to about 4.0, or from about 1.0 to about 2.4. Also useful are aluminosilicates including zeolites.

Dispersants—The compositions may contain from about 0.1%, to about 10%, by weight of the composition of dispersants. Suitable water-soluble organic materials are the homo- or co-polymeric acids or their salts, in which the polycarboxylic acid may contain at least two carboxyl radicals separated from each other by not more than two carbon atoms. The dispersants may also be alkoxylated derivatives of polyamines, and/or quaternized derivatives.

Enzymes—The compositions may contain one or more detergent enzymes which provide cleaning performance and/or fabric care benefits. Examples of suitable enzymes include hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination may be a cocktail of conventional applicable enzymes like protease, lipase, cutinase and/or cellulase in conjunction with amylase. Enzymes can be used at their art-taught levels, for example at levels recommended by suppliers such as Novozymes and Genencor. Typical levels in the compositions are from about 0.0001% to about 5% by weight of the composition. When enzymes are present, they can be used at very low levels, e.g., from about 0.001% or lower; or they can be used in heavier-duty laundry detergent formulations at higher levels, e.g., about 0.1% and higher. In accordance with a preference of some consumers for “non-biological” detergents, the compositions may be either or both enzyme-containing and enzyme-free.

Chelant—The compositions may contain less than about 5%, or from about 0.01% to about 3%, by weight of the composition, of a chelant such as citrates; nitrogen-containing, P-free aminocarboxylates such as EDDS, EDTA and DTPA; aminophosphonates such as diethylenetriamine pentamethylenephosphonic acid and, ethylenediamine tetramethylenephosphonic acid; nitrogen-free phosphonates e.g., HEDP; and nitrogen or oxygen containing, P-free carboxylate-free chelants such as compounds of the general class of certain macrocyclic N-ligands such as those known for use in bleach catalyst systems.

Brighteners—The compositions may also comprise a brightener (also referred to as “optical brightener”) and may include any compound that exhibits fluorescence, including compounds that absorb UV light and reemit as “blue” visible light. Non-limiting examples of useful brighteners include: derivatives of stilbene or 4,4′-diaminostilbene, biphenyl, five-membered heterocycles such as triazoles, pyrazolines, oxazoles, imidiazoles, etc., or six-membered heterocycles (coumarins, naphthalamide, s-triazine, etc.). Cationic, anionic, nonionic, amphoteric and zwitterionic brighteners can be used. Suitable brighteners include those commercially marketed under the trade name Tinopal-UNPA-GX® by Ciba Specialty Chemicals Corporation (High Point, N.C.).

Bleach system—Bleach systems suitable for use herein contain one or more bleaching agents. Non-limiting examples of suitable bleaching agents include catalytic metal complexes; activated peroxygen sources; bleach activators; bleach boosters; photobleaches; bleaching enzymes; free radical initiators; H₂O₂; hypohalite bleaches; peroxygen sources, including perborate and/or percarbonate and combinations thereof. Suitable bleach activators include perhydrolyzable esters and perhydrolyzable imides such as, tetraacetyl ethylene diamine, octanoylcaprolactam, benzoyloxybenzenesulphonate, nonanoyloxybenzene [symbol] isulphonate, benzoylvalerolactam, dodecanoyloxybenzenesulphonate. Other bleaching agents include metal complexes of transitional metals with ligands of defined stability constants.

Stabilizer—The compositions may contain one or more stabilizers and thickeners. Any suitable level of stabilizer may be of use; exemplary levels include from about 0.01% to about 20%, from about 0.1% to about 10%, or from about 0.1% to about 3% by weight of the composition. Non-limiting examples of stabilizers suitable for use herein include crystalline, hydroxyl-containing stabilizing agents, trihydroxystearin, hydrogenated oil, or a variation thereof, and combinations thereof. In some aspects, the crystalline, hydroxyl-containing stabilizing agents may be water-insoluble wax-like substances, including fatty acid, fatty ester or fatty soap. In other aspects, the crystalline, hydroxyl-containing stabilizing agents may be derivatives of castor oil, such as hydrogenated castor oil derivatives, for example, castor wax. The hydroxyl containing stabilizers are disclosed in U.S. Pat. Nos. 6,855,680 and 7,294,611. Other stabilizers include thickening stabilizers such as gums and other similar polysaccharides, for example gellan gum, carrageenan gum, and other known types of thickeners and rheological additives. Exemplary stabilizers in this class include gum-type polymers (e.g. xanthan gum), polyvinyl alcohol and derivatives thereof, cellulose and derivatives thereof including cellulose ethers and cellulose esters and tamarind gum (for example, comprising xyloglucan polymers), guar gum, locust bean gum (in some aspects comprising galactomannan polymers), and other industrial gums and polymers.

Silicones—Suitable silicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.

Perfume—Perfume can be included as an adjunct ingredient, for example as neat perfume (i.e. not encapsulated). This can be in addition to perfume utilized as a hydrophobic benefit agent in the delayed-release solid particle. Such perfume can be the same as, or different from, the perfume encapsulated in the delayed-release solid particle.

Fabric Hueing Agents—The composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof. Suitable fabric hueing agents also include dyes, dye-clay conjugates, and organic and inorganic pigments.

Structurants—Useful structurant materials that may be added to adequately suspend the benefit agent containing delivery particles include polysaccharides, for example, gellan gum, waxy maize or dent corn starch, octenyl succinated starches, derivatized starches such as hydroxyethylated or hydroxypropylated starches, carrageenan, guar gum, pectin, xanthan gum, and mixtures thereof; modified celluloses such as hydrolyzed cellulose acetate, hydroxy propyl cellulose, methyl cellulose, and mixtures thereof; modified proteins such as gelatin; hydrogenated and non-hydrogenated polyalkenes, and mixtures thereof; inorganic salts, for example, magnesium chloride, calcium chloride, calcium formate, magnesium formate, aluminum chloride, potassium permanganate, laponite clay, bentonite clay and mixtures thereof; polysaccharides in combination with inorganic salts; quaternized polymeric materials, for example, polyether amines, alkyl trimethyl ammonium chlorides, diester ditallow ammonium chloride; imidazoles; nonionic polymers with a pKa less than 6.0, for example polyethyleneimine, polyethyleneimine ethoxylate; polyurethanes.

Anti-agglomeration agents—Useful anti-agglomeration agent materials include, divalent salts such as magnesium salts, for example, magnesium chloride, magnesium acetate, magnesium phosphate, magnesium formate, magnesium boride, magnesium titanate, magnesium sulfate heptahydrate; calcium salts, for example, calcium chloride, calcium formate, calcium acetate, calcium bromide; trivalent salts, such as aluminum salts, for example, aluminum sulfate, aluminum phosphate, aluminum chloride hydrate and polymers that have the ability to suspend anionic particles such as suspension polymers, for example, polyethylene imines, alkoxylated polyethylene imines, polyquaternium-6 and polyquaternium-7.

### Release Test Method

The ability of the delayed-release solid particles of the present invention to release the hydrophobic benefit agent encapsulated therein during a simulated laundry washing process is measured according to the following RELEASE TEST METHOD.

### Materials:

### Aria Laundry Washing Powder

### Deionized Water

Delayed-release solid particles (e.g. comprising aminosilicone (Magnasoft Plus) as a hydrophobic benefit agent)

### Procedures:

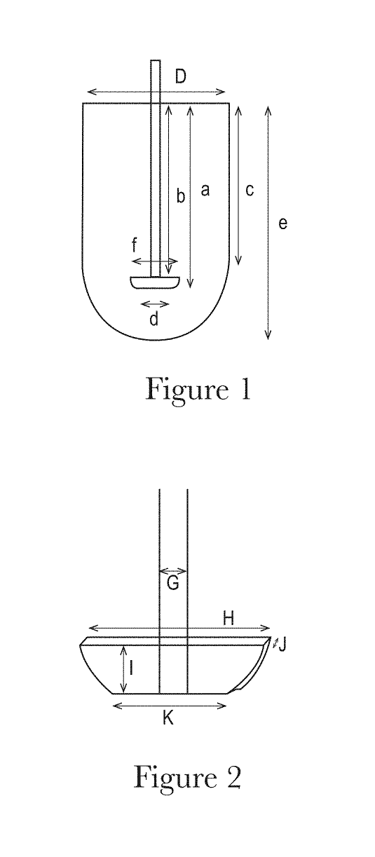

1. Dissolve the Aria Laundry Washing Powder using deionized water to form “Ariel aqueous solution”.
2. Depending on the type of washing conditions, the concentration of Ariel aqueous solution is prepared as follows:
   a. 6,670 ppm of Aria aqueous solution for Front loader washing
   b. 625 ppm of Aria aqueous solution for Top loader washing
3. Add 800 ml of Ariel aqueous solution to a tergetometer/USP-2 dissolution tester (or equivalent). The tergetometer and its respective dimensions are shown in FIG. 1 (wherein a=138 mm, b=118 mm, c=120 mm, d=40 mm, e=163 mm, f=72 mm, and D=103 mm). The impeller utilized in the tergetometer of FIG. 1 and its respective dimensions are shown in FIG. 2 (shaft diameter (“G”)=10 mm, top dimension (“H”)=75 mm, height (“I”)=19 mm, depth (“J”)=4 mm, bottom dimension (“K”)=42 mm). These dimensions are important in order to accurately replicate the washing conditions described herein.
4. Set the tergetometer water bath temperature at 40 deg. Celsius.
5. Depending on the type of washing conditions, the tergetometer rotation speed are set as follows:
   a. 200 rpm for Front loading
   b. 80 rpm for Top Loading
6. Add delayed-release solid particles in an amount corresponding to 200 ppm of aminosilicone (MAGNASOFT PLUS) into the tergetometer containing the 800 ml of Ariel solution.
7. Approximately, 5.0 ml aliquots are extracted from the tergetometer using a syringe connected with a 35 μm filter via a peristaltic pump over a range of time intervals (Time intervals of 0, 1, 3, 5, 7.5, 10, 12.5, 15, 20, 30, 60, 90 and 120 minutes).
8. Depend on the type of washing conditions, the positions of syringe used to extract aliquots are located as follows:
   a. Front loader washing—aliquots extracted from ˜2-3 cm below the surface of solution
   b. Top loader washing—aliquots extracted from the middle of solution
9. Each aliquot then undergoes inductively coupled plasma (ICP) analysis as follows.

### Inductively Coupled Plasma Analysis

Silicone analysis is conducted using inductively coupled plasma-optical emission spectrometer (ICP-OES). The above mentioned aliquots at specified time intervals are measured via ICP. ICP calibration standards are made using the Magnasoft Plus aminosilicone with Ariel Matrices solution (6,670 or 625 ppm depending on the type of washing conditions) in 10, 25, 50, 100, 200 and 250 ppm concentrations.

### Preparation of Standards

1. Prepare Tergitol Magnasoft (TMS) emulsion using Magnasoft oil (20 g), Tergitol NP10 (2.5 g), acetic acid (4 drops) and deionized or ultra-pure water (77.5 g). Therefore the TMS emulsion comprising of 20 wt. % of Magnasoft benefit agent.
2. Accurately measure out approximately 625 mg of TMS emulsion (20 wt. %) in a bottle and record the weight
3. Top up the bottle with approximately 500 g of Ariel matrices solutions solution (6,670 or 625 ppm depending on the type of washing conditions) and record the weight
4. Mix thoroughly both solution and calculate the concentration of Magnasoft concentration (ppm):
   Magnasoft (ppm)=(weight of Magnasoft (mg)×20%)/(weight of Ariel matrices solution (g)×1000)
5. Prepare the standard calibration concentrations of 10, 25, 50, 100, 200 via dilution using Ariel matrices solutions

### ICP Method Details

Turn on ICP-OES and condenser
Fit peristaltic pump tubing into the pump and start pump
Start plasma flame and leave it on for around an hour before use
Perform blank and calibration standards at the start of every session
Wipe down sample feed tube before placing into each test sample
Take note down concentration readings for each test sample at 250.690 nm wavelength
Calculate percent (%) silicone released for each test sample

### EXAMPLES

The following are non-limiting examples of delayed-release particles of the present invention. All parts, percentages, and ratios herein are by weight unless otherwise specified. Some components may come from suppliers as dilute solutions. The amount stated reflects the weight percent of the active material, unless otherwise specified.

### Example 1 (SC 129MS)

| Material | Weight % |
|---|---|
| MAGNASOFT PLUS | 27.59 |
| Polyvinylpyrrolidone (M_{w} = 40,000) | 68.69 |
| TERGITOL NP-10 | 3.45 |
| “Low MW” Chitosan (from Sigma Aldrich) | 0.28 |

The delayed-release solid particle of Example 1 is made as follows. First, an emulsion of aminosilicone (MAGNASOFT PLUS) is prepared. 20 g of MAGNASOFT PLUS and 2.5 g of TERGITOL NP-10 are mixed with 77.5 g of distilled water in a beaker and the mixture is stirred using a magnetic stirrer at about 500 rpm. 4 drops of acetic acid using a plastic eye dropper is added to the mixture and kept stirring at about 500 rpm until an aminosilicone emulsion is formed.

In a separate 250 ml lab bottle, a separate polymer solution is prepared. 4.98 g of polyvinylpyrrolidone and 0.02 g of chitosan is weighed and added into the 250 ml lab bottle. 240 ml of distilled water is added to the 250 ml lab bottle and stirred using magnetic stirrer at about 500 rpm. 2 ml of acetic acid is added to the mixture and the mixture is stirred using the magnetic stirrer at room temperature to ensure all polymers are dissolved to form a clear polymer solution.

The clear polymer solution is heated to 50° C. and 10 mL of the separately prepared aminosilicone emulsion (equivalent to 2 g MAGNASOFT PLUS) is added to the clear polymer solution in the 250 ml lab bottle under stirring using a magnetic stirrer at about 500 rpm.

A Buchi 290B spray dryer (or equivalent) is turned on and warmed on “open-loop” mode. The inlet temperature is set to 170° C., the aspiration rate is set to 100%, and the pump speed is set to “20”.

After continued stirring for about 30 min, the 250 ml lab bottle solution is moved to the spray dryer and placed in a water bath to keep the temperature of the lab bottle solution at 50° C. during spray drying.

The lab bottle solution is spray dried for approximately 1 hour. After spray drying, the feeding pump on the spray dryer is stopped and the system is cooled down to below 50° C. before the spray dryer is switched off. The resulting delayed-release solid particle particles are transferred to a beaker and kept in a vacuum desiccator at room temperature until further use. The resulting delayed-release solid particles have a weight ratio of polyvinylpyrrolidone to chitosan of about 249:1

### Example 2 (SC 127MS)

| Material | Weight % |
|---|---|
| MAGNASOFT PLUS | 27.59 |
| Polyvinylpyrrolidone (M_{w} = 40,000) | 68.62 |
| TERGITOL NP-10 | 3.45 |
| “Low MW” Chitosan (from Sigma Aldrich) | 0.34 |

The delayed-release solid particle of Example 2 is made according to the same process as Example 1, except that 4.975 g of PVP and 0.025 g chitosan is weighed and added into the 250 ml lab bottle. The resulting delayed-release solid particles have a weight ratio of polyvinylpyrrolidone to chitosan of about 199:1.

### Example 3 (SC 126MS)

| Material | Weight % |
|---|---|
| MAGNASOFT PLUS | 27.59 |
| Polyvinylpyrrolidone (M_{w} = 40,000) | 68.28 |
| TERGITOL NP-10 | 3.45 |
| “Low MW” Chitosan (from Sigma Aldrich) | 0.69 |

The delayed-release solid particle of Example 3 is made according to the same process as Example 1, except that 4.95 g of PVP and 0.05 g chitosan is weighed and added into the 250 ml lab bottle. The resulting delayed-release solid particles have a weight ratio of polyvinylpyrrolidone to chitosan of about 99:1.

### Example 4 (SC 104MS)

| Material | Weight % |
|---|---|
| MAGNASOFT PLUS | 27.59 |
| Polyvinylpyrrolidone (M_{w} = 40,000) | 67.59 |
| TERGITOL NP-10 | 3.45 |
| “Low MW” Chitosan (from Sigma Aldrich) | 1.38 |

The delayed-release solid particle of Example 4 is made according to the same process as Example 1, except that 4.9 g of PVP and 0.1 g chitosan is weighed and added into the 250 ml lab bottle. The resulting delayed-release solid particles have a weight ratio of polyvinylpyrrolidone to chitosan of about 49:1.

### Example 5 (SC 135MS)

| Material | Weight % |
|---|---|
| MAGNASOFT PLUS | 27.59 |
| Polyvinylpyrrolidone (M_{w} = 40,000) | 67.17 |
| TERGITOL NP-10 | 3.45 |
| “Low MW” Chitosan (from Sigma Aldrich) | 1.79 |

The delayed-release solid particle of Example 5 is made according to the same process as Example 1, except that 4.87 g of PVP and 0.13 g chitosan is weighed and added into the 250 ml lab bottle. The resulting delayed-release solid particles have a weight ratio of polyvinylpyrrolidone to chitosan of about 38:1.

### Comparative Example A (SC 083MS)

| Material | Weight % |
|---|---|
| MAGNASOFT PLUS | 27.59 |
| Polyvinylpyrrolidone (M_{w} = 40,000) | 68.97 |
| TERGITOL NP-10 | 3.45 |
| “Low MW” Chitosan (from Sigma Aldrich) | 0.00 |

The solid particle of Comparative Example A is made according to the same process as Example 1, except that 5.0 g of PVP (and no chitosan) is weighed and added to the 250 ml lab bottle.

### Comparative Example B (SC 130MS)

| Material | Weight % |
|---|---|
| MAGNASOFT PLUS | 27.59 |
| Polyvinylpyrrolidone (M_{w} = 40,000) | 68.83 |
| TERGITOL NP-10 | 3.45 |
| “Low MW” Chitosan (from Sigma Aldrich) | 0.14 |

The solid particle of Comparative Example B is made according to the same process as Example 1, except that 4.99 g of PVP and 0.01 g chitosan is weighed and added into the 250 ml lab bottle. The resulting solid particles have a weight ratio of polyvinylpyrrolidone to chitosan of about 499:1.

### Comparative Example C (SC 106MS)

| Material | Weight % |
|---|---|
| MAGNASOFT PLUS | 27.59 |
| Polyvinylpyrrolidone (M_{w} = 40,000) | 66.21 |
| TERGITOL NP-10 | 3.45 |
| “Low MW” Chitosan (from Sigma Aldrich) | 2.76 |

The delayed-release solid particle of Comparative Example C is made according to the same process as Example 1, except that 4.8 g of PVP and 0.2 g chitosan is weighed and added into the 250 ml lab bottle. The resulting delayed-release solid particles have a weight ratio of polyvinylpyrrolidone to chitosan of about 24:1.

### Silicone Release Performance

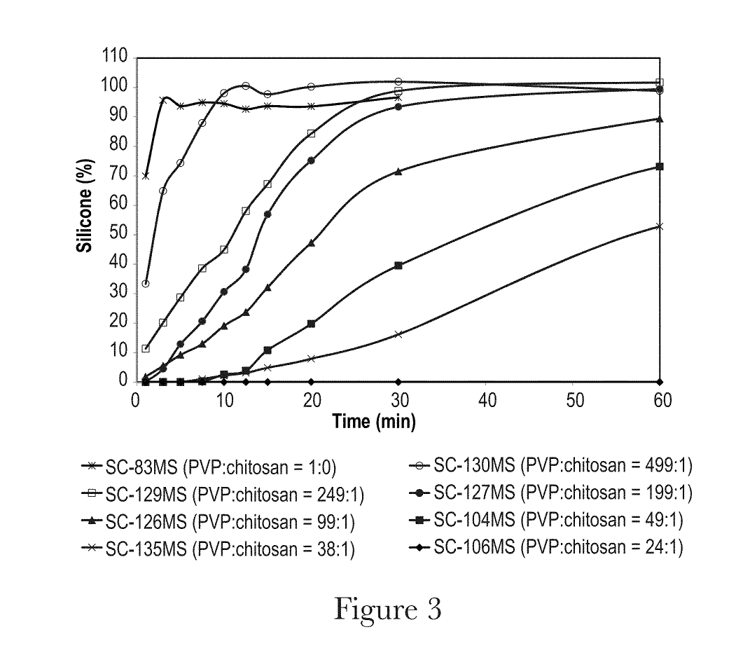

The delayed-release solid particles of Examples 1-5 and Comparative Examples A-C are tested according to the RELEASE TEST METHOD to determine amount of silicone released from the delayed-release solid particle (as a percentage) as a function of time. The data from this testing is shown in the graphical plot of FIG. 3 and in Table 1 below.

TABLE 1

| | | Weight % | % Silicone Released | | |
|---|---|---|---|---|---|
| | | of Chitosan | | | Max 30- |
| Sample ID | Example | in Particle | 5 min | 10 min | 120 min |
| SC 129MS | Ex. 1 | 0.28 | 29 | 45 | 99 |
| SC 127MS | Ex. 2 | 0.35 | 13 | 31 | 99 |
| SC 126MS | Ex. 3 | 0.69 | 9 | 19 | 99 |
| SC 104MS | Ex. 4 | 1.38 | 0 | 4 | 85 |
| SC 135MS | Ex. 5 | 1.79 | 0 | 2 | 65 |
| SC 083MS | Comp. Ex. A | 0.00 | 93 | 95 | 97 |
| SC 130MS | Comp. Ex. B | 0.14 | 74 | 98 | 99 |
| SC 106MS | Comp. Ex. C | 2.76 | 0 | 0 | <1 |

These data illustrate that if the amount of chitosan is too low (especially in relation to the amount of polyvinylpyrrolidone), or not present at all, the hydrophobic benefit agent can be released too quickly from the delayed-release solid particle (see, e.g., Comparative Examples A and B). If the amount of chitosan is too high (especially in relation to the amount of polyvinylpyrrolidone), the hydrophobic benefit agent may not be sufficiently released from the delayed-release solid particle (see, e.g., Comparative Example C).

### Microscopy Imaging Analysis

Digital imaging of delayed-release solid particles when in contact with Ariel aqueous solution is captured using an Olympus polarized microscope. The delayed-release solid particles are placed on a microscopy glass slide and approximately 2-3 drops of Ariel aqueous solution (i.e. Ariel Laundry Washing Powder dissolved in deionized water at a concentration of 6,670 ppm) using a plastic eye dropper is added to the particles at room temperature. The time evolutions of particles in contact with the Ariel aqueous solution are captured and analyzed using “Stream Basic” software linked to the microscope.

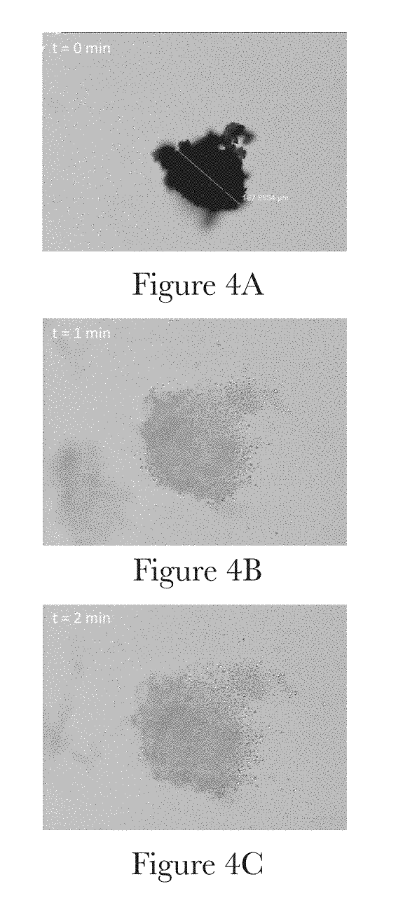

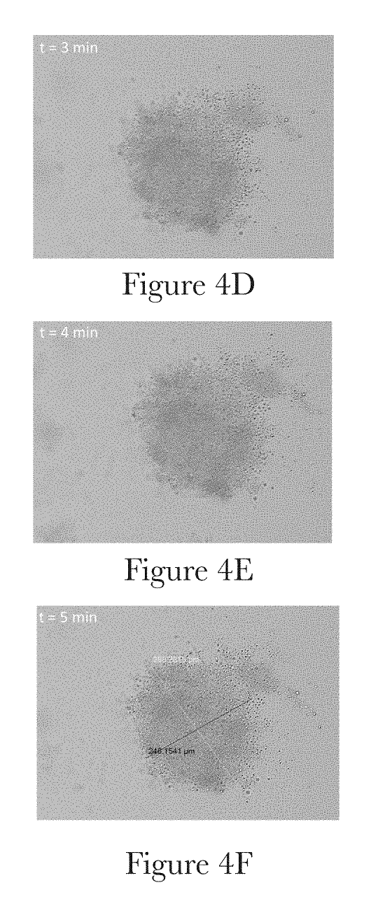

FIGS. 4A through 4F are time-lapse micrographs showing the delayed-release solid particle according to Example 2 (SC-127) when in contact with the aqueous media. The micrographs show the delayed-release solid particle when in contact with the aqueous media at the beginning of the test (FIG. 4A), after 1 minute (FIG. 4B), after 2 minutes (FIG. 4C), after 3 minutes (FIG. 4D), after 4 minutes (FIG. 4E), and after 5 minutes (FIG. 4F). The delayed-release solid particle of Example 2 when in contact with the aqueous media tends to swell after contact with the test medium, increasing in size about 1.7× compared to the dry solid form of the delayed-release solid particle.

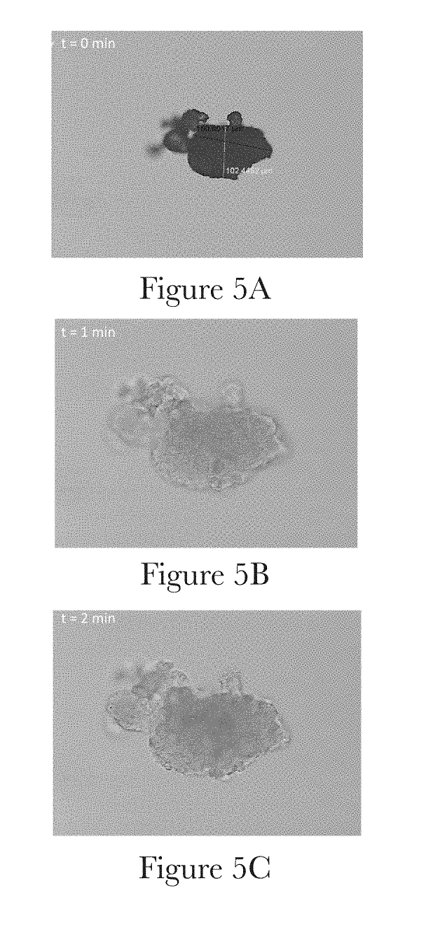

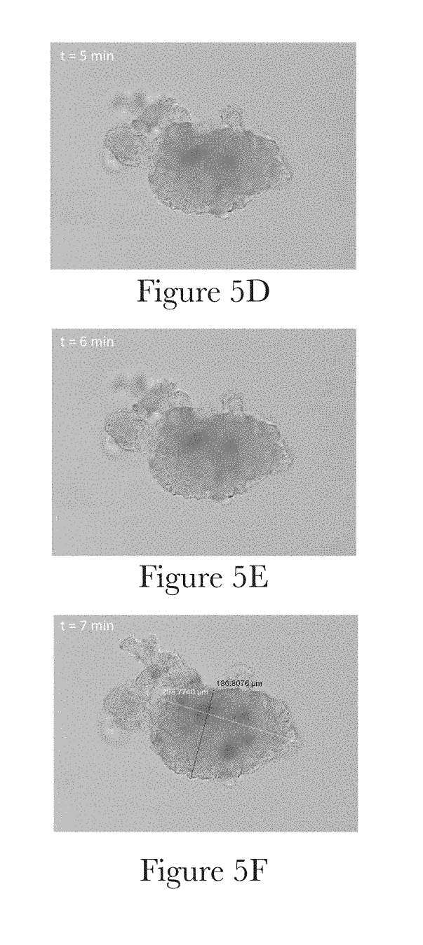

FIGS. 5A through 5F are time-lapse micrographs showing the delayed-release solid particle according to Example 4 (SC-104) when in contact with the aqueous media. The micrographs show the delayed-release solid particle when in contact with the aqueous media at the beginning of the test (FIG. 5A), after 1 minute (FIG. 5B), after 2 minutes (FIG. 5C), after 5 minutes (FIG. 5D), after 6 minutes (FIG. 5E), and after 7 minutes (FIG. 5F). The delayed-release solid particle of Example 4 when in contact with the aqueous media tends to swell after contact with the test medium, increasing in size about 1.8× compared to the dry solid form of the delayed-release solid particle.

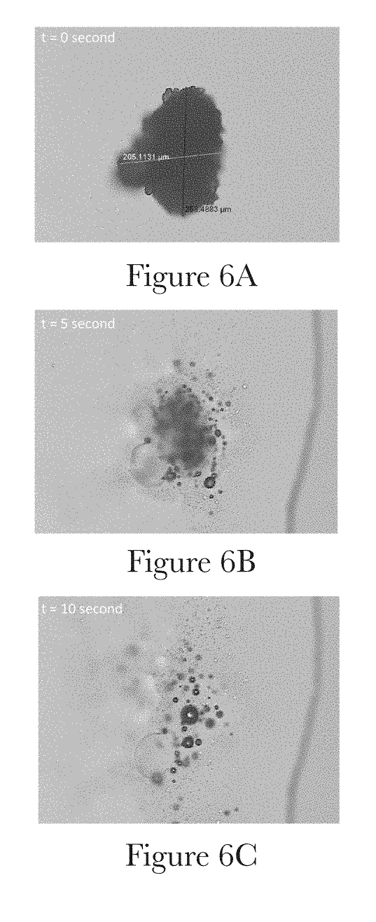

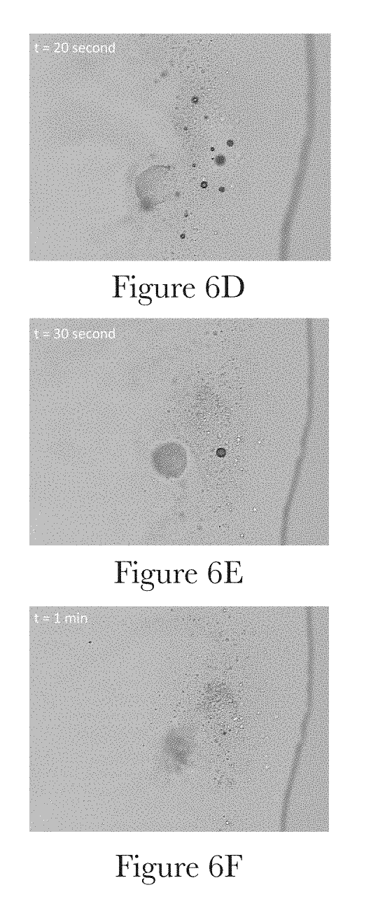

FIGS. 6A through 6F are time-lapse micrographs showing the solid particle according to Comparative Example A (SC-83) when in contact with the aqueous media. The micrographs show the solid particle when in contact with the aqueous media at the beginning of the test (FIG. 6A), after 5 seconds (FIG. 6B), after 10 seconds (FIG. 6C), after 20 seconds (FIG. 6D), after 30 seconds (FIG. 6E), and after 1 minute (FIG. 6F). The solid particle of Comparative Example A when in contact with the aqueous media almost completely disintegrates within 20 seconds.

The micrographs shown in FIGS. 4-6 illustrate that the delayed-release solid particles of Examples 2 and 4 provide for delayed-release of the hydrophobic benefit agent whereas the solid particle of Comparative Example A disintegrates and thereby releases the hydrophobic benefit agent very soon after contact with the aqueous test medium.

### Fabric Softening Performance

Delayed-release particles of the present invention are evaluated for fabric softening performance according to the following method.

Panel grading is used to assess the softness characteristics. The panelists are trained and calibrated, and panel the fabrics versus the reference fabric using the following panel score units (PSU) where: −4 is described as significantly very poor versus reference, −3 is poor versus reference, −2 is slightly poor versus reference, −1 is unsure about negative difference versus reference, 0 is no difference versus reference, +1 is unsure about positive difference versus reference, +2 is slightly better versus reference, +3 is superior versus reference and +4 is significantly superior versus reference. Four replica fabrics are prepared for each sample, and each fabric is paneled once by three different panelists and the average panel score is calculated.

The fabric softening performance of Comparative Example A (SC 083) when added to the wash cycle at different times (i.e. at 0 minutes, at 15 minutes, and at 30 minutes) is provided in Table 2 as follows.

TABLE 2

| | Single Cycle Softness | |
|---|---|---|
| Sample | PSU | Si μg/g Fabric |
| 100 ppm SC083 | 0 | 54 |
| added at time = 0 | | |
| 100 ppm SC083 | 0.7 s | 198 |
| added at time = 15 | | |
| 100 ppm SC083 | 0.9 s | 150 |
| added at time = 30 | | |

The data in Table 2 above shows that if the particles of Comparative Example A, which readily dissolves and releases silicone, are added at different time intervals during the washing cycle, enhanced deposition of silicone on fabric occurs when the particles are added later in the wash cycle. The data therefore suggests that deposition of silicone on fabric during washing can be increased by the delay of silicone release during the wash cycle. Delayed silicone release can help in increasing silicone availability for deposition during the later half of the laundry cycle.

The fabric softening performance of Example 4, Example 5 and Comparative Example A when the particles are each added to the wash at the beginning of the wash cycle (i.e. at 0 minutes) is provided in Table 3 as follows.

TABLE 3

| | | Softness PSU in full |
|---|---|---|
| | | scale front loader |
| | | washing machine |
| SC 083 | Comp. Ex. A | 0 s |
| Ref + 150 ppm SC- | Ex. 4 | 2.3 s |
| 104MS | | |
| Ref + 150 ppm SC- | Ex. 5 | 1.2 s |
| 135MS | | |

The particles of Examples 4 and 5 exhibit a greater delay in release of silicone during the wash cycle, and correspondingly exhibit a greater fabric softness benefit in 2 cycle softness testing results. Example 4, which has a highly preferable ratio of polyvinylpyrrolidone to chitosan, shows an optimal delay profile and a greater fabric softening benefit as compared to Comparative Example A.

The following are non-limiting examples of consumer product articles which are single unit dose laundry detergent pouches for washing machines.

| Ingredients | | | |
|---|---|---|---|
| (All levels are in weight percent of | | | |
| the total pouch composition) | 6 | 7 | 8 |
| Linear C₉-C₁₅ Alkylbenzene | 18.5 | 25.3 | 22.0 |
| sulfonic acid | | | |
| C12-14 alkyl ethoxy 3 sulfate or | 8.8 | 7.6 | 15.1 |
| C12-15 alkyl ethoxy 2.5 sulfate | | | |
| C₁₂₋₁₄ alkyl 7-ethoxylated alcohol | 14.5 | 4.1 | 3.8 |
| C₁₂₋₁₄ alkyl 9-ethoxylated alcohol or | | | |
| C₁₄₋₁₅ alkyl 7-ethoxylated alcohol | | | |
| (or mixture thereof) | | | |
| Citric Acid | 0.7 | 0.6 | 0.7 |
| Fatty acid | 6.1 | 10.3 | 6.1 |
| HEDP | 2.1 | 0.8 | 2.3 |
| Enzymes (protease, amylase, | 1.4 | 1.0 | 1.1 |
| mannanase, cellulase, | | | |
| xyloglucanase, pectate lyase, lipase | | | |
| or mixture thereof, expressed as % | | | |
| enzyme raw material solutions) | | | |
| Brightener 49 | 0.3 | 0.3 | 0.3 |
| Ethoxylated polyethylene imine PEI | 5.4 | 3.1 | 3.3 |
| 600 E20 ex BASF | | | |
| PEG 6000/polyvinylacetate | 1.5 | — | 2.2 |
| copolymer (40:60) ex BASF | | | |
| 1,2 Propanediol | 15.2 | 17.2 | 12.3 |
| Glycerine | 5.0 | 4.8 | 3.9 |
| Water | 9.5 | 10.3 | 10.4 |
| Di propylene glycol | 0.2 | 0.5 | 4.0 |
| Antifoam AF8017 ex Dow Corning | — | 0.3 | 0.3 |
| Perfume | 1.7 | 2.4 | 2.0 |
| Perfume micro capsules (expressed | — | 0.7 | — |
| as % encapsulated oil) | | | |
| Accusol 880 structurant ex DOW | — | 0.3 | — |
| (as raw material ex supplier) | | | |
| PPG 400 | — | 0.8 | — |
| Cationically modified hydroxy- | — | 0.5 | — |
| ethyl cellulose* | | | |
| Hueing dye | 0.03 | — | 0.07 |
| Structurant (hydrogenated castor | 0.13 | 0.14 | 0.13 |
| oil) | | | |
| Delayed-release Solid Particles of | 8.0 | 8.0 | 9.0 |
| Example 4 | | | |

| | |
|---|---|
| Mono-ethanolamine, tri- | to between pH 7.0 and 8.7 |
| ethanolamine or NaOH (or mixture | |
| thereof) | |
| Other laundry adjuncts (sulfite, | To 100% |
| dyes, opacifiers, MgCl2, bitrex, | |
| minors, . . .) | |
| PVA film | Yes |

In Examples 6-8, the level of Delayed-release Solid Particles can be increased (e.g. to about 35%) by adjusting the remaining ingredients to balance.

The following are non-limiting examples of consumer product compositions which are granular laundry detergent compositions for hand washing or top-loading washing machines.

| | EXAMPLE | | | | | |
|---|---|---|---|---|---|---|
| | 9 | 10 | 11 | 12 | 13 | 14 |
| | (wt %) | (wt %) | (wt %) | (wt %) | (wt %) | (wt %) |
| Linear alkylbenzenesulfonate | 20 | 22 | 20 | 15 | 19.5 | 20 |
| C₁₂₋₁₄ Dimethylhydroxyethyl | 0.7 | 0.2 | 1 | 0.6 | 0.0 | 0 |
| ammonium chloride | | | | | | |
| AE3S | 0.9 | 1 | 0.9 | 0.0 | 0.4 | 0.9 |
| AE7 | 0.0 | 0.0 | 0.0 | 1 | 0.1 | 3 |
| Sodium tripolyphosphate | 5 | 0.0 | 4 | 9 | 2 | 0.0 |
| Zeolite A | 0.0 | 1 | 0.0 | 1 | 4 | 1 |
| 1.6R Silicate (SiO₂:Na₂O at ratio 1.6:1) | 7 | 5 | 2 | 3 | 3 | 5 |
| Sodium carbonate | 25 | 20 | 25 | 17 | 18 | 19 |
| Polyacrylate MW 4500 | 1 | 0.6 | 1 | 1 | 1.5 | 1 |
| Random graft copolymer¹ | 0.1 | 0.2 | 0.0 | 0.0 | 0.05 | 0.0 |
| Carboxymethyl cellulose | 1 | 0.3 | 1 | 1 | 1 | 1 |
| Stainzyme ® (20 mg active/g) | 0.1 | 0.2 | 0.1 | 0.2 | 0.1 | 0.1 |
| Protease (Savinase ®, 32.89 mg active/g) | 0.1 | 0.1 | 0.1 | 0.1 | | 0.1 |
| Amylase - Natalase ® (8.65 mg active/g) | 0.1 | 0.0 | 0.1 | 0.0 | 0.1 | 0.1 |
| Lipase - Lipex ® (18 mg active/g) | 0.03 | 0.07 | 0.3 | 0.1 | 0.07 | 0.4 |
| Fluorescent Brightener | 0.1 | 0.06 | 0.1 | 0.18 | 0.1 | 0.1 |
| DTPA | 0.6 | 0.8 | 0.6 | 0.25 | 0.6 | 0.6 |
| MgSO₄ | 1 | 1 | 1 | 0.5 | 1 | 1 |
| Sodium Percarbonate | 0.0 | 5.2 | 0.1 | 0.0 | 0.0 | 0.0 |
| Sodium Perborate Monohydrate | 4.4 | 0.0 | 3.85 | 2.09 | 0.78 | 3.63 |
| NOBS | 1.9 | 0.0 | 1.66 | 0.0 | 0.33 | 0.75 |
| TAED | 0.58 | 1.2 | 0.51 | 0.0 | 0.015 | 0.28 |
| Sulphonated zinc phthalocyanine | 0.0030 | 0.0 | 0.0012 | 0.0030 | 0.0021 | 0.0 |
| S-ACMC | 0.1 | 0.0 | 0.0 | 0.0 | 0.06 | 0.0 |
| Direct Violet Dye (DV9 or DV99 or DV66) | 0.0 | 0.0 | 0.0003 | 0.0001 | 0.0001 | 0.0 |
| Neat Perfume | 0.5 | 0.5 | 0.5 | 0.5 | 0.5 | 0.5 |
| Delayed-release Solid Particles of Example 4 | 0.7 | 1.0 | 2.3 | 0.5 | 1.2 | 0.8 |

| | |
|---|---|
| Sulfate/Moisture | Balance |

The following are non-limiting examples of consumer product compositions which are granular laundry detergent compositions for front-loading automatic washing machines.

| | EXAMPLE | | | | | |
|---|---|---|---|---|---|---|
| | 15 | 16 | 17 | 18 | 19 | 20 |
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE3S | 0 | 4.8 | 1.0 | 5.2 | 4 | 4 |
| C12-14 Alkylsulfate | 1 | 0 | 1 | 0 | 0 | 0 |
| AE7 | 2.2 | 0 | 2.2 | 0 | 0 | 0 |
| C₁₀₋₁₂ Dimethyl | 0.75 | 0.94 | 0.98 | 0.98 | 0 | 0 |
| hydroxyethylammonium chloride | | | | | | |
| Crystalline layered silicate (δ-Na₂Si₂O₅) | 4.1 | 0 | 4.8 | 0 | 0 | 0 |
| Zeolite A | 5 | 0 | 5 | 0 | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at ratio 2:1) | 0.08 | 0 | 0.11 | 0 | 0 | 0 |
| Soil release agent | 0.75 | 0.72 | 0.71 | 0.72 | 0 | 0 |
| Acrylic Acid/Maleic Acid Copolymer | 1.1 | 3.7 | 1.0 | 3.7 | 2.6 | 3.8 |
| Carboxymethylcellulose | 0.15 | 1.4 | 0.2 | 1.4 | 1 | 0.5 |
| Protease - Purafect ® (84 mg active/g) | 0.2 | 0.2 | 0.3 | 0.15 | 0.12 | 0.13 |
| Amylase - Stainzyme Plus ® (20 mg active/g) | 0.2 | 0.15 | 0.2 | 0.3 | 0.15 | 0.15 |
| Lipase - Lipex ® (18.00 mg active/g) | 0.05 | 0.15 | 0.1 | 0 | 0 | 0 |
| Amylase - Natalase ® (8.65 mg active/g) | 0.1 | 0.2 | 0 | 0 | 0.15 | 0.15 |
| Cellulase - Celluclean ™ (15.6 mg active/g) | 0 | 0 | 0 | 0 | 0.1 | 0.1 |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer (EDDS) | | | | | | |
| Hydroxyethane di phosphonate (HEDP) | 0.2 | 0.2 | 0.2 | 0.2 | 0.2 | 0.2 |
| MgSO₄ | 0.42 | 0.42 | 0.42 | 0.42 | 0.4 | 0.4 |
| Perfume | 0.5 | 0.6 | 0.5 | 0.6 | 0.6 | 0.6 |
| Suds suppressor agglomerate | 0.05 | 0.1 | 0.05 | 0.1 | 0.06 | 0.05 |
| Soap | 0.45 | 0.45 | 0.45 | 0.45 | 0 | 0 |
| Sulphonated zinc phthalocyanine (active) | 0.0007 | 0.0012 | 0.0007 | 0 | 0 | 0 |
| S-ACMC | 0.01 | 0.01 | 0 | 0.01 | 0 | 0 |
| Direct Violet 9 (active) | 0 | 0 | 0.0001 | 0.0001 | 0 | 0 |
| Neat Perfume | 0.5 | 0.5 | 0.5 | 0.5 | 0.5 | 0.5 |
| Delayed-release Solid Particles of Example 4 | 2.0 | 1.5 | 0.9 | 2.2 | 1.5 | 0.8 |

| | |
|---|---|
| Sulfate/Water & Miscellaneous | Balance |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A delayed-release solid particle comprising:
a polymer-based matrix comprising from about 20% to about 90%, by weight of said delayed-release solid particle, of polyvinylpyrrolidone and from about 0.15% to about 5%, by weight of said delayed-release solid particle, of chitosan, wherein a weight ratio of said polyvinylpyrrolidone to said chitosan is from about 30:1 to about 400:1; and
from about 10% to about 80%, by weight of said delayed-release solid particle, of a hydrophobic benefit agent encapsulated by said polymer-based matrix; and
less than about 15%, by weight of said delayed-release solid particle, of water.

2. The delayed-release solid particle of claim 1, wherein said weight ratio of said polyvinylpyrrolidone to said chitosan is from about 30:1 to about 300:1.

3. The delayed-release solid particle of claim 1, wherein said weight ratio of said polyvinylpyrrolidone to said chitosan is from about 30:1 to about 200:1.

4. The delayed-release solid particle of claim 1, wherein said weight ratio of said polyvinylpyrrolidone to said chitosan is from about 30:1 to about 100:1.

5. The delayed-release solid particle of claim 1, wherein said weight ratio of said polyvinylpyrrolidone to said chitosan is from about 40:1 to about 50:1.

6. The delayed-release solid particle of claim 1, wherein said delayed-release solid particle comprises from about 0.2% to about 3%, by weight of the delayed-release particle, of chitosan.

7. The delayed-release solid particle of claim 1, wherein said chitosan has a viscosity average molecular weight of from about 1,500 to about 800,000 Daltons.

8. The delayed-release solid particle of claim 1, wherein said chitosan has a viscosity average molecular weight of from about 5,000 to about 250,000 Daltons.

9. The delayed-release solid particle of claim 1, wherein said chitosan has a viscosity average molecular weight of from about 50,000 to about 190,000 Daltons.

10. The delayed-release solid particle of claim 1, wherein said polyvinylpyrrolidone has a weight average molecular weight of from about 10,000 to about 360,000 Daltons.

11. The delayed-release solid particle of claim 1, wherein said polyvinylpyrrolidone has a weight average molecular weight of from about 20,000 to about 80,000 Daltons.

12. The delayed-release solid particle of claim 1, wherein said hydrophobic benefit agent is a liquid at 25° C.

13. The delayed-release solid particle of claim 1, wherein said delayed-release particle comprises from about 10% to about 60%, by weight of said delayed-release particle, of said hydrophobic benefit agent.

14. The delayed-release solid particle of claim 1, wherein said delayed-release particle comprises from about 20% to about 40%, by weight of said delayed-release particle, of said hydrophobic benefit agent.

15. The delayed-release solid particle of claim 1, wherein said hydrophobic benefit agent is selected from the group consisting of silicones, organic conditioning oils, hydrocarbon oils, fatty esters, metathesized unsaturated polyol esters, silane-modified oils, other conditioning agents, perfume, and mixtures thereof.

16. The delayed-release solid particle of claim 1, wherein said hydrophobic benefit agent is a perfume.

17. The delayed-release solid particle of claim 1, wherein said hydrophobic benefit agent is a silicone.

18. The delayed-release solid particle of claim 1, wherein said hydrophobic benefit agent is selected from the group consisting of siloxanes, silicone gums, aminosilicones, terminal aminosilicones, alkyl siloxane polymers, cationic organopolysiloxanes, and mixtures thereof.

19. The delayed-release solid particle of claim 1, wherein said hydrophobic benefit agent is an aminosilicone.

20. The delayed-release solid particle of claim 1, wherein said delayed-release solid particle further comprises an emulsification agent.

21. The delayed-release solid particle of claim 20, wherein said emulsification agent is a nonionic surfactant.

22. The delayed-release solid particle of claim 1, wherein said particle has a particle size of from about 1 to about 3,000 micrometers.

23. The delayed-release solid particle of claim 1, wherein said particle has a particle size of from about 1 to about 500 micrometers.

24. A process for making a delayed-release solid particle according to claim 1, said process comprising the steps of:
preparing a benefit agent solution comprising said hydrophobic benefit agent;
mixing said polyvinylpyrrolidone, said chitosan, and water to form a polymer solution;
mixing said benefit agent solution and said polymer solution to form a mixture solution; and
removing water from said mixture solution to form said delayed-release solid particle.

25. The process of claim 24, wherein said benefit agent solution is prepared by mixing said hydrophobic benefit and an emulsification agent.

26. The process of claim 25, wherein said emulsification agent is a nonioninc surfactant and said benefit agent solution comprises an emulsion of said hydrophobic benefit agent and said nonionic surfactant.

27. An anhydrous consumer product composition comprising:
i) a plurality of delayed-release particles according to claim 1; and
ii) an adjunct ingredient selected from group of anhydrous carrier, surfactant, perfume, and mixtures thereof.

28. A consumer product article comprising an anhydrous composition encased in a water-soluble pouch, wherein said anhydrous composition comprises a plurality of delayed-release particles according to claim 1.
